(19) United States
(12) Patent Application Publication
(10) Pub. No.: US 2023/0146955 A1
(43) Pub. Date: May 11, 2023

(54) TOOL FOR ACTUATING AN ADJUSTING ELEMENT OF A SANITARY FITTING

(71) Applicant: Grohe AG, Hemer (DE)

(72) Inventor: Ole Benedikt KOSTORZ, Menden (DE)

(73) Assignee: Grohe AG, Hemer (DE)

(21) Appl. No.: 17/910,901

(22) PCT Filed: Feb. 19, 2021
(86) PCT No.: PCT/EP2021/054180

§ 371 Date: Sep. 12, 2022

(30) Foreign Application Priority Data
Mar. 13, 2020 (DE) 10 2020 106 888.3

(51) Int. Cl. B25B 23/142; B25B 13/48

(52) U.S. Cl. CPC B25B 23/1427; B25B 13/481; E03C 2201/00

(57) ABSTRACT

A tool (1) for actuating an adjustment element (2) of a sanitary faucet (3), comprising at least:
a shaft (4) having a longitudinal axis (5); and
a drive geometry (6), which is disposed on the shaft (4) and can be connected to the adjustment element (2) for transmitting a torque, wherein the drive geometry (6) can be elastically deformed such that the drive geometry (6) at least partially disengages from the adjustment element (2) when a predetermined torque is reached;

a kit (15) comprising a sanitary faucet (3) and the tool (1); and

the use of the tool (1) for actuating an adjustment element (2) of a sanitary faucet (3).

This invention relates to a tool for actuating a sanitary faucet. Such sanitary faucets are used, in particular, to provide a liquid on demand at washbasins, sinks, showers and/or bathtubs.

Sanitary faucets can have adjustment elements, which, in particular after the sanitary faucets have been mounted on a support, can be used to adjust functions of the sanitary faucets. These adjustment elements are often difficult to reach after they have been mounted on the support, i.e., tools such as socket wrenches are used to actuate them. In so doing, torques can be transmitted to the adjustment elements, which can result in damage to the adjustment elements or other components of the sanitary faucet.

Therefore the invention addresses the problem of solving at least a part of the issues described with reference to the prior art and, in particular, of providing a tool for actuating an adjustment element of a sanitary faucet, which can prevent damage to the sanitary faucet.

This problem is solved by a tool according to the features of the independent claim. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A tool for actuating an adjustment element of a sanitary faucet having at least the components listed below contributes to solving the problem:
a shaft having a longitudinal axis; and
a drive geometry, which is disposed on the shaft and can be connected to the adjustment element for transmitting a torque, wherein the drive geometry can be elastically deformed such that the drive geometry at least partially disengages from the adjustment element when a predetermined torque is reached.

This invention relates to a tool for actuating an adjustment element for a sanitary faucet, which is used, in particular, to provide water on demand at a washbasin, sink, shower and/or bathtub. The sanitary faucet can, for instance, be designed in the manner of a single-lever mixer. Further, the sanitary faucet can have a faucet body, which may be at least partially made of plastic and/or metal, such as brass or a zinc alloy. In addition, the faucet body can be attached in particular to a support, such as a (kitchen) countertop, a wall, a sink, a wash basin or a sink unit. For this purpose, at least one opening can be provided in the support.

In addition, the sanitary faucet may have a mixing valve for mixing cold water and warm water to form a mixed water. The mixing valve can, for instance, be designed in the manner of a single-lever mixing cartridge and/or be disposed at least partially in the faucet body of the sanitary faucet. The mixing valve can have a mixing body, which in particular is at least partially made of plastic and/or is at least partially cylindrical in shape. In the mixing body, a control lever is at least partially movably mounted, which is used to actuate the mixing valve. For this purpose, the control lever is connected in particular to an actuating lever of the sanitary faucet, for instance by means of a screw/bolted connection or plug-in connection. The actuating lever can be rotated about an axis of rotation, in particular for setting a mixed-water temperature, and/or rotated about an axis of rotation (in particular extending orthogonally to the axis of rotation), in particular for setting a discharge quantity of the mixed water. Furthermore, the mixing valve can have a stationary control disk and a mobile control disk. The stationary control disk and the mobile control disk can each be flat or disk-shaped, in particular. Furthermore, the stationary control disk and the mobile control disk may at least be partially made of ceramic. The stationary control disk is in particular immovable, i.e., in particular not displaceable or non-rotatable relative to the housing, disposed in the housing, whereas the mobile control disk can be moved (in particular be rotatable relative to the housing) in particular by the actuating lever on the stationary control disk.

Furthermore, the sanitary faucet can have a thermostatic mixer, which can be used to mix the cold water and the hot water, in particular to the warm water. The cold water can be supplied to the thermostatic mixing valve, for instance from a public water supply network, in particular via a cold-water line and/or the hot water can be supplied to the thermostatic mixing valve, for instance from the public water supply network and/or a hot-water heater, in particular via a hot-water line. The cold-water line and/or the hot-water line may be, for instance, a pipe or a flexible hose. A cold-water temperature of the cold water is in particular at most 25° C. (Centigrade), preferably 1° C. to 25° C., particularly preferably 5° C. to 20° C. and/or a hot-water temperature of the hot water is in particular at most 100° C., preferably 25° C. to 100° C., particularly preferably 55° C. to 65° C. The cold water and hot water can be mixed to a warm water in particular in a warm-water mixing chamber of the thermostatic mixing valve.

The thermostatic mixing valve can also comprise an expansion element and/or, in particular, a gate valve that can be actuated by the expansion element. The expansion element extends in particular along a longitudinal axis and/or is at least partially rotationally symmetrical about its longitudinal axis. Furthermore, the expansion material element may comprise an expansion material, such as wax, which can be used to move a working piston of the expansion material element. In particular, the expansion element can expand as a function of the mixed-water temperature of the mixed water, in particular in parallel to its longitudinal axis. The gate valve can be at least partially made of metal or plastic. Furthermore, the gate valve can in particular be at least partially cylindrical or tubular in shape. The gate valve is connected to the expansion element in such a way that a change in length of the expansion element results in an actuation or a motion of the gate valve, in particular in the direction of its longitudinal axis. By actuating or moving the gate valve, a mixing ratio between the cold water and the hot water can be changed, whereby a warm-water temperature of the mixed warm water can be influenced by the thermostatic mixing valve. For this purpose, the gate valve can, in particular, change a gap width of a cold-water control gap and/or a gap width of a hot-water control gap of the thermostatic mixing valve. The cold water can be supplied to the warm-water mixing chamber of the thermostatic mixing valve, in particular via the cold-water control gap, and/or the hot water can be supplied to the warm-water mixing chamber of the thermostatic mixing valve, in particular via the hot-water control gap. The cold-water control gap and/or the hot-water control gap are formed in particular between the gate valve and a body of the thermostatic mixing valve or a cartridge adapter of the mixing valve. In particular, the actuation of the gate valve results in a simultaneous change in the gap width of the cold-water control gap and the hot-water control gap. An increase of the gap width of the cold-water control gap results in particular in a reduction in size of the hot-water control gap. Accordingly, a reduction of the gap width of the cold-water control gap results in particular in an increase in size of the hot-water control gap.

Furthermore, an extension or lengthening of the expansion material element results in particular in an increase of the gap width of the cold-water control gap and a reduction of the gap width of the hot-water control gap. Accordingly, shrinking or shortening the expansion material element results in particular in a reduction of the gap width of the cold-water control gap and an increase of the gap width of the hot-water control gap. An increasing mixed-water temperature of the mixed water can thus result in a decreasing warm-water temperature of the warm water. Furthermore, a decreasing mixed-water temperature of the mixed water can thus result in an increasing warm-water temperature of the warm water. If the mixed-water temperature of the mixed water exceeds, for instance, a limit value the gate valve can close the hot-water control gap completely. The warm-water temperature of the warm water is then equal to the cold-water temperature of the cold water. In other words, the warm water in this case consists exclusively of the cold water. The warm-water temperature of the warm water can be for instance, 1° C. to 60° C. The warm water mixed by the thermostatic mixer can then be routed in particular to the mixing valve, through which the warm water can be mixed with (further) cold water to form the mixed water.

A connecting element can be used to actuate the gate valve by the expansion element. The gate valve can at least partially be made of metal or plastic. Furthermore, the connecting element can be flat and/or disk-shaped. The gate valve can be coupled to the expansion element by the connecting element in particular in such a way that a change in length of the expansion element results in an actuation or adjustment of the gate valve. The connecting element can engage in a first groove of the expansion material element or a connecting sleeve of the expansion material element and in a second groove of the gate valve. In particular, the first groove of the expansion material element extends around the longitudinal axis of the expansion material element and/or the second groove of the gate valve extends around the longitudinal axis of the gate valve. The mixed water may at least partially flow around the expansion material element. For this purpose, the expansion material element can at least partially delimit a mixed-water channel, through which the mixed water mixed by the mixing valve can be routed to the outlet opening of the outlet. In particular, the expansion element can rest against a stop surface. In particular, the drive piston and/or a longitudinal end of the expansion element rests against the stop surface. The expansion element can also be pressed against the stop surface, in particular by a return spring.

The tool can be used to actuate an adjustment element of the sanitary faucet. The adjustment element can be, for instance, a threaded element, a screw/bolt and/or shaft. The adjustment element can, for instance, adjust the warm-water temperature, the mixed-water temperature, a flow rate of the cold water, a flow rate of the hot water, a flow rate of the warm water, and/or a flow rate of the mixed water. For instance, the adjustment element can be used to adjust a position of the stop surface for the expansion element and/or a position of the expansion element in the faucet body. For this purpose, the stop surface can be formed, for instance, at a longitudinal end of the adjustment element. In particular, the adjustment element has an (external) thread, such that rotation of the adjustment element results in displacement of the adjustment element. The adjustment element is in particular disposed in the faucet body and/or (in particular only) accessible via a mounting opening of the faucet body.

The tool has a shaft having a longitudinal axis. In particular, the shaft is an elongated portion of the tool. The shaft can be rigid or flexible. Furthermore, the shaft can, for instance, be designed in the manner of a cardan shaft or comprise a cardan shaft. In addition, the shaft may have a diameter of, for instance, 0.5 cm (centimeters) to 5 cm. The tool may have a tool length along the longitudinal axis that is, for instance, 5 cm (centimeters) to 50 cm. An actuating handle may also be formed at a longitudinal end of the shaft, which can be used by a user to rotate the tool about the longitudinal axis by a user. The longitudinal axis can therefore also be an axis of rotation of the tool.

In addition, a drive geometry is disposed on the shaft, which drive geometry can be connected to the adjustment element in particular in such a way that a torque can be transmitted to the adjustment element via the tool. In particular, the drive geometry is formed at a longitudinal end of the shaft. In particular, the drive geometry can be fitted onto or inserted into the adjustment element. Furthermore, the drive geometry can be connected to the adjustment element, in particular in a form-fitting manner. The drive geometry can be elastically deformed, i.e., the drive geometry disengages at least partially from the adjustment element when a predetermined torque is reached. In particular, the elastic deformation of the drive geometry is reversible, such that the drive geometry can assume its original shape after the elastic deformation. For this purpose, the drive geometry may be at least partially made of plastic or rubber. In addition, the complete tool may be at least partially made of plastic or rubber. Furthermore, the tool can in particular be integrally designed, i.e., in particular not be composed of several parts. The tool, for instance, can be designed, in particular, in the manner of a plastic die-cast component. In particular, the drive geometry is designed in such a way that the predetermined torque, at which the drive geometry deforms, is smaller than a torque that can cause damage to the sanitary faucet.

The specified torque can therefore be adapted to a maximum permissible torque for actuating the adjustment element. The torque at which the drive geometry deforms can be specified, for instance, by selecting a suitable material for the drive geometry, by selecting a suitable hardness for the material of the drive geometry, and/or by a suitable geometric design of the drive geometry. The specified torque can be, for instance, 0.1 Nm (Newton meters) to 10 Nm. The at least partial detachment of the drive geometry from the adjustment element may mean, in particular, that rotation of the tool results in less rotation or no rotation of the adjustment element and/or that the adjustment element slides on or in the drive geometry. This can prevent damage to the adjustment element and other components of the sanitary faucet.

The drive geometry can be designed in the manner of a hexagon socket. In this way, the drive geometry can be mounted in particular on a bolt head of the adjustment element, which is designed in the manner of a hexagonal head.

The drive geometry can spread when the specified torque is reached. Spreading can cause a change of a diameter of the drive geometry. For instance, the diameter of the drive geometry may increase, in particular in a radial direction, i.e., in particular orthogonally to the longitudinal axis.

The drive geometry may have a plurality of drive jaws. In particular, the drive jaws can be areas or elements that limit and/or form the drive geometry, in particular in the radial direction. In particular, the drive geometry may have two drive jaws. The drive jaws can have a (largely) C-shaped and/or ring-segment-shaped cross section orthogonal to the longitudinal axis.

In particular, the drive jaws are separated from each other by at least one slot. In particular, the at least one slot extends from a longitudinal end of the tool in parallel to the longitudinal axis through the drive geometry and/or into the shaft. The at least one slot may have a length in parallel to the longitudinal axis of, for instance, 5 mm (millimeters) to 40 mm.

The shaft may have a plurality of plates that are twisted relative to each other about a longitudinal axis. In particular, the shaft may have a plurality of plates. In addition, the shaft can be made entirely of the plates. For instance, the individual panels may have a length of 10 mm to 100 mm parallel to the longitudinal axis, a width of 5 mm to 40 mm orthogonal to the longitudinal axis, and/or (orthogonal to the length and width) a thickness of 1 mm to 5 mm. Adjacent panels can be rotated relative to one another about the longitudinal axis, for instance, at an angle of 45° to 90°, preferably (substantially) 90°. As a result, the shaft can be bent and at the same time has sufficient torsional stiffness.

Adjacent panels may overlap. In particular, this can mean that the plates interlock in a chain-like manner. Furthermore, this may mean in particular that the panels extend longitudinally to at least one flat side of an adjacent panel. In addition, this can mean that the panels taper off longitudinally on at least one flat side of the adjacent panel or that their width is continuously reduced in the direction of the longitudinal axis until their width matches in particular the thickness of the adjacent panel.

According to another aspect, a kit for discharging a fluid on demand is also disclosed, comprising a sanitary faucet and a tool proposed herein. This has the advantage that the specified torque, at which the drive geometry of the tool deforms, can be adapted to the sanitary faucet included in the kit or to its adjustment element. For further details, please refer to the description of the tool.

In accordance with a still further aspect, a use of a tool proposed herein for actuating an adjustment element of a sanitary faucet is also proposed. For further details, please refer to the description of the tool.

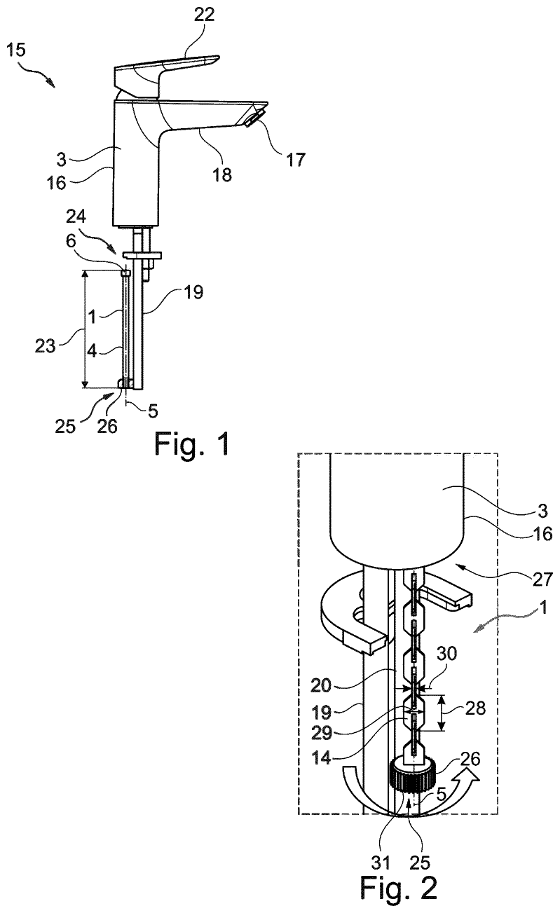

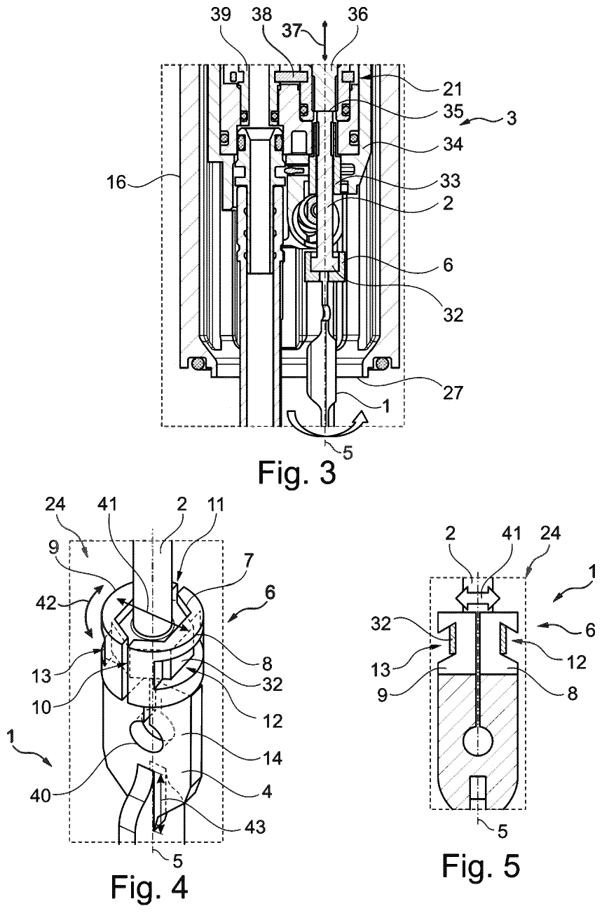

The invention and the technical environment are explained in more detail below with reference to the figures. It should be noted that the figures show particularly preferred variants of the embodiment of the invention, but the invention is not limited thereto. The same reference numerals are used for the same components in the figures. In an exemplary and schematic manner
FIG. 1 shows a side view of a kit with a first embodiment variant of a tool and a sanitary faucet;
FIG. 2 shows a perspective view of the first embodiment variant of the tool and the sanitary faucet;
FIG. 3 shows a sectional view of the first embodiment variant of the tool and the sanitary faucet;
FIG. 4 shows a partial perspective view of the first embodiment variant of the tool; and
FIG. 5 shows a side view of a second embodiment variant of the tool.

FIG. 1 shows a side view of a kit 15 with a first embodiment variant of a tool 1 and a sanitary faucet 3. The sanitary faucet 3 comprises a faucet body 16 having an outlet 18 with an outlet opening 17. The faucet body 16 can be attached to a support not shown here. A thermostatic mixer 21 of the sanitary faucet 3 shown in FIG. 3 can be supplied with hot water via a hot-water line 19 and with cold water via a cold-water line 20 shown in FIG. 2. The mixing valve 21 can be used to mix the cold water and the hot water to form a mixed warm water having a warm-water temperature. The warm water can then be fed to a mixing valve, which is also not shown here, through which the warm water can be mixed with cold water to form a mixed water having a desired mixed-water temperature. The mixed-water temperature and an extraction quantity of the mixed water can be adjusted by an actuating lever 22 of the sanitary faucet 3. The tool 1 has a shaft 4 extending along a longitudinal axis 5 of the tool 1. Furthermore, the tool 1 has a tool length 23 along the longitudinal axis 5. A drive geometry 6 is formed at a first longitudinal end 24 of the tool 1, and an actuating handle 26 is formed at an opposite second longitudinal end 25, by means of which a user can rotate the tool 1 about the longitudinal axis 5. The longitudinal axis 5 therefore simultaneously represents an axis of rotation of the tool 1.

FIG. 2 shows an enlarged view of the first embodiment variant of the tool 1 of the sanitary faucet 3 in the area of an assembly opening 27 of the faucet body 16, after the tool 1 has been connected to an adjustment element 2 of the sanitary faucet 3 shown in FIG. 3. The shaft 4 of the tool 1 comprises a plurality of plates 14, wherein adjacent plates 14 are rotated by 90° with respect to one another about the longitudinal axis 5. The individual plates 14 have a length 28, a width 29 and a thickness 30. At the second longitudinal end 25 of the tool 1, the actuating handle 26 having an outer corrugation 31 can be seen.

FIG. 3 shows a sectional view of the first embodiment variant of the tool 1 and the sanitary faucet 3. The drive geometry 6 of the tool 1 is inserted through the mounting opening 27 of the faucet body 16 onto a screw head 32 of an adjustment element 2 of the sanitary faucet 3. In this case, the adjustment element 2 is designed in the shape of a bolt, which is bolted into a threaded sleeve 33. The threaded sleeve 33 is supported in a body adapter 34 of the faucet body 16. The adjustment element 2 has a stop surface 35 for an expansion element 36 at its end opposite the screw head 32. The expansion element 36 can expand in an axial direction 37, i.e., in parallel to the longitudinal axis 5 of the tool 1 or of the adjustment element 2, as a function of the mixed-water temperature of the mixed water, and in so doing adjust a gate valve 39 in the axial direction 37 via a connecting element 38. The gate valve 39 can be used to adjust a hot water gap for the hot water and a cold-water gap for the cold water, which gaps are not shown here, such that a mixing ratio of the hot water and the cold water and thus a warm-water temperature of the warm water mixed from the hot water and cold water can be adjusted by the gate valve 39. By rotating the tool 1 about the longitudinal axis 5, the stop surface 35 and thus the expansion material element 36 can be adjusted in the axial direction 37. In this way, the thermostatic mixing valve 21 can be used to adjust a maximum warm-water temperature of the mixed warm water. After the warm-water temperature has been adjusted, the tool 1 can be pulled off again from the adjustment element 2.

FIG. 4 shows a perspective view of the first embodiment variant of the tool 1 in the area of its drive geometry 6. The drive geometry 6 is formed at the first longitudinal end 24 of the tool 1 in the manner of a hexagon socket 7 and is fitted onto the bolt head 32 of the adjustment element 2. In this way, a torque can be transferred to the adjustment element 2 and the tool 1 can be used to rotate the adjustment element 2 about the longitudinal axis 5. The drive geometry 6 comprises a first drive jaw 8 and a second drive jaw 9, which have a (substantially) C-shaped and/or ring-segment-shaped cross-section orthogonal to the longitudinal axis 5. The drive jaws 8, 9 are separated from each other by a first slot 10 and second slot 11, which continue in parallel to the longitudinal axis 5 into the adjacent plate 14 of the shaft 4 of the tool 1, where they open into a drilled hole 40. When a predetermined torque is reached during the actuation of the adjustment element 2, the drive jaws 8, 9 spread elastically outwards in a radial direction 41 (i.e., orthogonally to the longitudinal axis 5) such that the drive geometry 6 slips in a circumferential direction 42 about the longitudinal axis 5 over the screw head 32 of the adjustment element 2, in that way preventing damage to the expansion material element 36 and/or the threaded sleeve 33 shown in FIG. 3. A first opening 12 is also formed in the first drive jaw 8 and a second opening 13 is formed in the second drive jaw 9, which increases the flexibility of the drive jaws 9, 10. Furthermore, it can be seen in FIG. 4 that adjacent panels 14 of the shaft 4 overlap in an overlap region 43 in parallel to the longitudinal axis 5.

FIG. 5 shows a side view of a second embodiment variant of the tool 1 in the region of its first longitudinal end 24. The second embodiment variant of the tool 1 differs from the first embodiment variant of the tool 1 only in that the first opening 12 of the first drive jaw 8 of the drive geometry 6 and the second opening 13 of the second drive jaw 9 of the drive geometry 6 are not orthogonal to the longitudinal axis 5, but are oblique. In this way, the torque, at which the drive jaws 8, 9 spread elastically outwards in the radial direction 41 and the drive geometry 6 disengages from the screw head 32 of the adjustment element 2, can be changed compared to the first embodiment variant of the tool 1. In all other respects, the second embodiment variant of the tool 1 is configured identically to the first embodiment variant of the tool 1.

This invention can prevent damage to a sanitary faucet.

### LIST OF REFERENCE NUMERALS

1 tool
2 adjustment element
3 sanitary faucet
4 shaft
5 longitudinal axis
6 drive geometry
7 hexagon socket
8 first drive jaw
9 second drive jaw
10 first slot
11 second slot
12 first opening
13 second opening
14 plate
15 kit
16 faucet body
17 outlet opening
18 outlet
19 hot water pipe
20 cold-water line
21 thermostatic mixing valve
22 actuating lever
23 tool length
24 first longitudinal end
25 second longitudinal end
26 actuating handle
27 installation opening
28 length
29 width
30 thickness
31 corrugations
32 screw head
33 threaded sleeve
34 body adapter
35 stop surface
36 expansion element
37 axial direction
38 connection element
39 gate valve
40 drilled hole
41 radial direction
42 circumferential direction
43 overlap area AMENDMENTS TO THE CLAIMS

1. A tool (1) for actuating an adjustment element (2) of a sanitary faucet (3), comprising at least:
a shaft (4) having a longitudinal axis (5); and
a drive geometry (6), which is disposed on the shaft (4) and can be connected to the adjustment element (2) for transmitting a torque, wherein the drive geometry (6) can be elastically deformed such that the drive geometry (6) at least partially disengages from the adjustment element (2) when a predetermined torque is reached.

2. The tool (1) according to claim 1, wherein the drive geometry (6) is designed in the manner of a hexagon socket (7).

3. The tool (1) according to claim 1, wherein the drive geometry (6) spreads when the predetermined torque is reached.

4. The tool (1) according to claim 1, wherein the drive geometry (6) has a plurality of drive jaws (8, 9).

5. The tool (1) according to claim 4, wherein the drive jaws (8, 9) are separated from each other by at least one slot (10, 11).

6. The tool (1) according to claim 4, wherein the drive jaws (8, 9) have at least one opening (12, 13).

7. The tool (1) according to claim 1, wherein the shaft (4) comprises a plurality of plates (14) twisted relative to each other about the longitudinal axis (5).

8. The tool (1) according to claim 7, wherein adjacent plates (14) overlap.

9. A kit (15) for discharging a liquid on demand, comprising a sanitary faucet (3) and a tool (1) according to claim 1.

10. Use of a tool (1) according to claim 1 for actuating an adjustment element (2) of a sanitary faucet (3).
